(19) United States
(12) Patent Application Publication
(10) Pub. No.: US 2012/0154278 A1
(43) Pub. Date: Jun. 21, 2012

(54) COMPUTER MOUSE

(75) Inventor: KUO-LUNG YANG, Tu-Cheng (TW)

(73) Assignee: HON HAI PRECISION INDUSTRY CO., LTD., Tu-Cheng (TW)

(21) Appl. No.: 13/070,529

(22) Filed: Mar. 24, 2011

(30) Foreign Application Priority Data
Dec. 15, 2010 (TW) 99143887

(51) Int. Cl. G06F 3/033

(52) U.S. Cl. 345/163

(57) ABSTRACT

A computer mouse includes a housing, a circuit board mounted in the housing, and a fan mounted in the housing and electrically connected with the circuit board. The housing includes a key portion at a front end thereof, and a supporting portion at a rear end thereof. The supporting portion defines a plurality of ventilation holes and through holes. The fan includes an inlet and an outlet perpendicular to the inlet. The fan draws ambient air through the ventilation holes and expels air through the through holes to ventilate a surface of the housing.

### BACKGROUND

1. Technical Field

The present disclosure relates to input devices, and more particularly to a computer mouse.

2. Description of Related Art

When a computer mouse is used outside of a climate controlled area, the temperature of the computer mouse may rise or fall depending on the ambient temperature. If the ambient temperature is too high or too low, the computer mouse may malfunction or be damaged.

What is needed, therefore, is a computer mouse to overcome or at least mitigate the described limitations.

### BRIEF DESCRIPTION OF THE DRAWINGS

The components of the drawings are not necessarily drawn to scale, the emphasis instead being placed upon clearly illustrating the principles of the embodiments of the display device. Moreover, in the drawings, like reference numerals designate corresponding parts throughout several views.

FIG. 1 is a schematic view of a computer mouse according to an exemplary embodiment.

FIG. 2 is a top partial cross-section of the computer mouse of FIG. 1.

FIG. 3 is a lateral partial cross-section of the computer mouse of FIG. 1.

### DETAILED DESCRIPTION

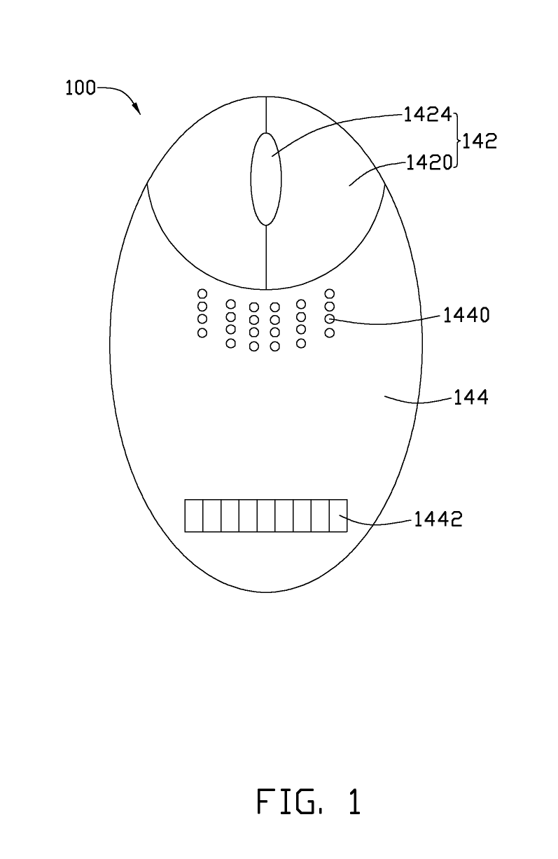

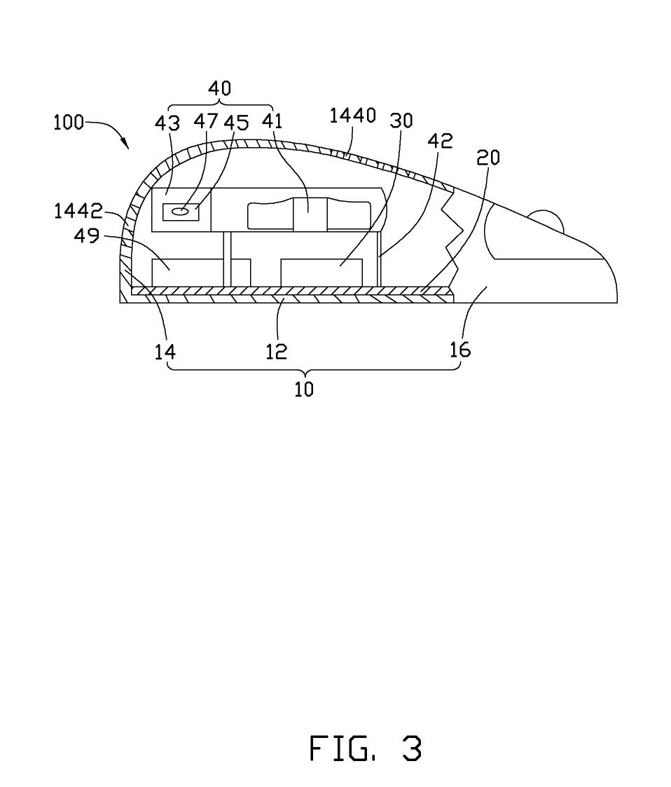

Referring to FIGS. 1 and 3, a computer mouse 100 includes a housing 10, a circuit board 20 received in the housing 10, a detector 30 mounted on the circuit board 20, and an air adjustment module 40 in the housing 10.

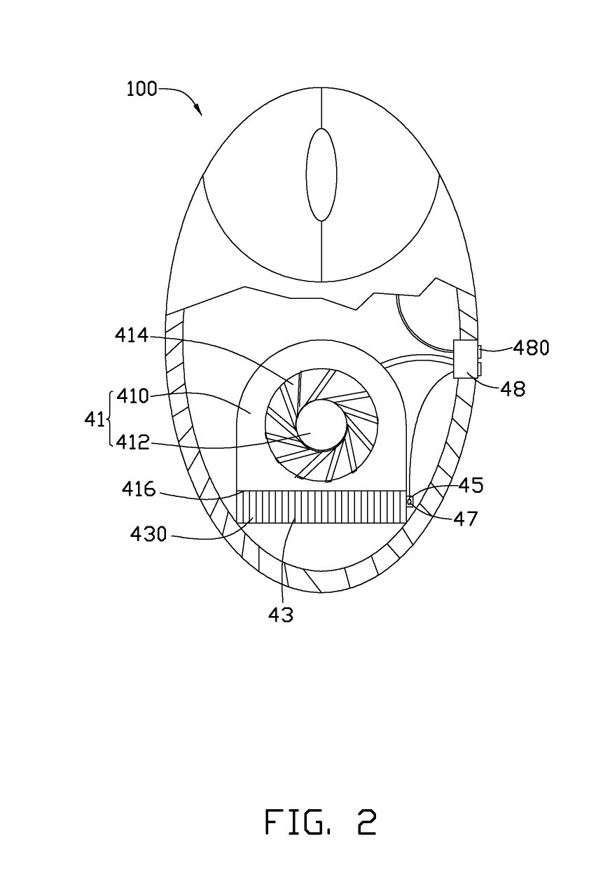

Referring also to FIG. 2, the housing 10 includes a base plate 12, an upper shell 14, and two lateral plates 16 connected between the base plate 12 and the upper shell 14. In this embodiment, the base plate 12 is integrally made with the lateral plates 16. In another embodiment, the base plate 12 can be integrally made with the upper shell 14.

The base plate 12 is flat. The upper shell 14 has a convex profile, a front end smoothly connecting with a front end of the base plate 12, and a rear end smoothly connecting with a rear end of the base plate 12. The upper shell 14 includes a key portion 142 at the front end thereof and a supporting portion 144 at the rear end thereof. The key portion 142 includes two keys 1420 and a scroll wheel 1424 therebetween.

The supporting portion 144 defines a plurality of ventilation holes 1440 and a plurality of through holes 1442 therein. The ventilation holes 1440 are defined at a front of the upper shell 14 and near the key portion 142. In particular, the ventilation holes 1440 are defined at a middle portion of a front end of the supporting portion 144. The ventilation holes 1440 allow ambient air to be drawn into the computer mouse 100. Alternatively, the ventilation holes 1440 can be defined at the lateral plates 16. The through holes 1442 defined at a rear end of supporting portion 144 allow air to be expelled from the interior of the computer mouse 100.

The circuit board 20 is mounted on the base plate 12. The detector 30 electrically connects the circuit board 20 and detects and records movement of the computer mouse 100.

The air adjustment module 40 is received in the computer mouse 100 and includes a fan 41, a plurality of fins 43, a heat pipe 45, and a heating pad 47.

The fan 41 is mounted on the base plate 12 by a securing bracket 42 and includes a casing 410 and an impeller 412 therein. The fan 41 defines an inlet 414 at a top of the casing 410 and an outlet 416 at a rear end of the casing 410. The outlet 416 is oriented perpendicular to the inlet 414. The inlet 414 corresponds to the ventilation holes 1440 of the upper shell 14, and the outlet 416 corresponds to the through holes 1442 of the upper shell 14.

Each of the fins 43 is made of metal having positive thermal conductivity, such as copper, aluminum or an alloy thereof. The fins 43 are arranged at the outlet 416 of the fan 41 and spaced from each other to define a plurality of passages 430 therebetween admitting air circulated by the fan 41. The heat pipe 45 extends through and thermally contacts the fins 43. The heat pipe 45 is soldered to the fins 43. In this embodiment, the heat pipe 45 is a vacuum-sealed pipe containing phase changeable working fluid. The heating pad 47 is attached to the heat pipe 45, warming the heat pipe 45 and the fins 43. Thermal grease can be applied between the heating pad 47 and the heat pipe 45. In this embodiment, the heating pad 47 is made of positive temperature coefficient ceramic. In another embodiment, the heating pad 47 can be directly mounted on the fins 43.

The heating pad 47 and the fan 41 are controlled by a switch module 48. In this embodiment, the switch module 48 is mounted on one of the lateral plates 16 and electrically connected to the circuit board 20. The switch module 48 provides controls 480 respectively turning the fan 41 and the heating pad 47 on and off.

In addition, a battery 49 is mounted on and electrically connected to the circuit board 20 to supply power to the fan 41 and the heating pad 47. In this embodiment, the battery 49 is a rechargeable battery which can be charged when the computer mouse 100 is connected to a computer.

In use of the computer mouse 100, activating the control 480 starts the fan 41. Ambient air is drawn through the ventilation holes 1440, and expelled through the through holes 1442 to ventilate a surface of the housing 10 thereby cooling the housing.

In cold weather, the fan 41 and the heating pad 47 are both activated by controls 480. Heat generated by the heating pad 47 is transferred to the fins 43 by the heat pipe 45, and evacuated by airflow from fan 45. The heated airflow through the through holes 1442 ventilates and warms the surface of the housing 10.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A computer mouse comprising:
a housing comprising a key portion at a front end thereof, and a supporting portion at a rear end thereof, the supporting portion defining a plurality of ventilation holes and through holes thereof;
a circuit board mounted in the housing; and
a fan mounted in the housing and electrically connected with the circuit board, the fan comprising an inlet and an outlet perpendicular to the inlet, the fan drawing ambient air through the ventilation holes and expelling airflow through the through holes to ventilate a surface of the housing.

2. The computer mouse of claim 1, further comprising a plurality of fins arranged at the outlet of the fan, and a heating pad thermally connected to the fins to heat the air to ventilate and warm the surface of the housing.

3. The computer mouse of claim 2, further comprising a heat pipe interconnecting the fins and the heating pad.

4. The computer mouse of claim 2, wherein the heating pad is positive temperature coefficient ceramic.

5. The computer mouse of claim 2, further comprising a switch module mounted in the housing and electrically connected to the circuit board, the switch module providing controls respectively turning the fan and the heating pad on and off.

6. The computer mouse of claim 2, further comprising a battery electrically connected to the circuit board to supply power to the fan and the heating pad.

7. The computer mouse of claim 1, wherein the housing comprises a base plate, an upper shell, and two lateral plates, the key portion formed at a front end of the upper shell, the supporting portion formed at a rear end of upper shell, the ventilation holes defined at a top of the upper shell and near the key portion.

8. The computer mouse of claim 1, wherein the inlet corresponds to the ventilation holes of the housing, and the outlet corresponds to the through holes of the housing,

9. A computer mouse comprising:
a housing comprising a key portion at a front end thereof, and a supporting portion at a rear end thereof, the supporting portion defining a plurality of ventilation holes and through holes thereof;
a circuit board mounted in the housing; and
an air adjustment module in the housing, the air adjustment module comprising:
a fan electrically connected with the circuit board;
a plurality of fins arranged at the outlet of the fan; and
a heating pad thermally connected to the fins and electrical connected to the circuit board;
wherein the heating pad produces heat to transfer to the fin, and the fan draws ambient air from the ventilation holes of the housing and expels the air through the heated fins and the through holes to ventilate and warm a surface of the housing.

10. The computer mouse of claim 9, wherein the air adjustment module further comprises a heat pipe thermally connecting with the fins and the heating pad.

11. The computer mouse of claim 9, wherein the heating pad is made of positive temperature coefficient ceramic.

12. The computer mouse of claim 9, further comprising a switch module mounted in the housing and electrically connected to the circuit board, the switch module providing controls respectively turning the fan and the heating pad on and off.

13. The computer mouse of claim 9, further comprising a battery electrically connected to the circuit board for supplying energy to the fan and the heating pad.

14. The computer mouse of claim 9, wherein the housing comprises a base plate, an upper shell, and two lateral plates, the key portion formed at a front end of the upper shell, the supporting portion formed at a rear end of the upper shell, the ventilation holes defined at a top of the upper shell and near the key portion.
